(19) United States
(12) Patent Application Publication
(10) Pub. No.: US 2011/0063670 A1
(43) Pub. Date: Mar. 17, 2011

(54) IMAGE FORMING SYSTEM

(76) Inventor: Shuichi ITO, Tokyo (JP)

(21) Appl. No.: 12/882,036

(22) Filed: Sep. 14, 2010

(30) Foreign Application Priority Data
Sep. 17, 2009 (JP) JP2009-216103

(51) Int. Cl. G06F 3/12

(52) U.S. Cl. 358/1.15

(57) ABSTRACT

An image forming system comprises: a processing portion provided with a function to execute jobs related to image formation; a position information acquisition portion for identifying a location where the processing portion is installed; a storage portion for storing an area and a function restricted in the area in association with each other, and a control portion for obtaining from the storage portion the function stored in association with the area which includes the installation location of the processing portion identified by the position information acquisition portion is included, and restricting an execution of the job a related to the function of the processing portion.

### RELATED APPLICATION

The present application is based on Patent Application No. 2009-216103 filed at the Japan Patent Office on Sep. 17, 2009 and which is hereby incorporated herein in its entirety.

### TECHNICAL FIELD

The present invention relates to an image forming system and an image forming apparatus which execute management related to function restrictions of an apparatus.

### BACKGROUND

If a confidential-document printing job is mistakenly executed by an output apparatus, such as a digital Multi Function Printer (MFP) and the like, installed in a lobby where the general public comes and goes, the contents of the document could possibly be leaked to the outside.

Accordingly, there is a system configured such that a user assigns a predetermined management code to each job and then the system restricts the location where the job can be executed as well as the function to be executed in that location (e.g., Japanese application patent laid-open publication No. 2008-257339). In this system, a management code, an MFP (IP address thereof) installed at the location indicated by the management code, and the type of job that can be executed at the MFP are registered in association with one another in the management server for administering the system. The server reads out the management code assigned to the job, and when the MFP specified for the output destination of that job is different from the MFP registered in association with the management code, or when the type of that job is different from the type of job registered in association with the management code, the server is designed to prohibit the execution of that job.

For example, it is assumed that a department name is used as a management code, and the contents registered in the management code, “Personnel department”, are the personnel department for the location where jobs can be executed and the printing job only for the function that can be executed. When the management code, “Personnel department”, is assigned to a job, the job cannot be executed at MFPs other than the MFP installed in the personnel department. Furthermore, even at the MFP installed in the personnel department, jobs other than the printing job cannot be executed.

In addition to the above, Japanese application patent laid-open publication No. 2005-31177 discloses an apparatus for automatically switching display languages and revising the date by identifying the country and the region where the apparatus was installed by the use of a GPS (Global Positioning System).

In Japanese application patent laid-open publication No. 2008-257339, when inputting a job into an MFP, a management code is assigned to the job to restrict the location where the job can be executed and the executable function, thereby preventing a confidential document from being mistakenly outputted as mentioned above. However, it takes time to make settings to restrict the location where the job can be executed and the executable function for each job.

In addition to the method of assigning a management code or the like to a job, one considerable method of restricting the job output location is a method for the apparatus, such as an MFP, which processes jobs to restrict the type of job executed by the apparatus. For example, when an MFP is installed in the lobby, functions may be restricted so that a printing job via a network would be prohibited and only a copying job is permitted.

However, when an MFP is configured to be movable, it is necessary to change settings related to the function restriction of the MFP every time the MFP is moved, and as the number of items to be changed becomes larger, more errors in setting tend to occur in the manual input process.

Furthermore, in the system disclosed in Japanese application patent laid-open publication No. 2008-257339, the server manages the location where an MFP is installed by storing the installation location in association with the IP address of the MFP installed in that location; and if the MFP installed therein is moved to a different location, discrepancy between the actual location and the registered data will occur.

For example, assuming that a user wants to print a highly confidential document concerning human resources at the personnel department and sets the management code, “Personnel department”, for the printing job, if the MFP installed in the personnel department was moved to the lobby before the user knows about it, and also if the data registered in the server has not been updated with regard to the moving of the MFP, the inputted printing job will be executed in the lobby despite the intention of the user. To prevent this incident from occurring, it is necessary to update the data registered in the server every time the MFP is moved, which takes time and the update tends to be carelessly forgotten.

In the apparatus disclosed in Japanese application patent laid-open publication No. 2005-31177, the location where the apparatus is installed can be automatically identified by the use of a GPS; however, the apparatus does not support the change of the function thereof.

Moreover, in the same manner as the function restriction setting of the apparatus, it is desirable that the setting of the security of the apparatus be changed according to the installation location. For example, it is desirable that the level of security, such as user authentication and encryption, be made high when an MFP is installed in the department that handles highly confidential documents, and when an MFP is installed in a public location or a lobby, the security level be made low; and such changes be made easily without consuming time.

To address the above problems, it is an object of the present invention to provide an image forming system capable of changing the function and the security of the image forming apparatus automatically or with a small number of man-hours according to the location where the apparatus is installed.

### SUMMARY

(1) To achieve at least one of the abovementioned objects, an image forming system, reflecting one aspect of the present invention comprises, a processing portion provided with a function to execute jobs related to image formation, a position information acquisition portion for identifying the location where the processing portion is installed, a storage portion for storing an area and the function restricted in the area in association with each other, and a control portion for obtaining from the storage portion the function stored in association with the area where the installation location of the processing portion identified by the position information acquisition portion is included, and restricting the execution of the job related to the function of the processing portion.

### BRIEF DESCRIPTION OF THE DRAWINGS

FIG. 1 is an explanatory drawing showing the configuration of an image forming system of an embodiment according to the present invention.

FIG. 2 is a block diagram showing the schematic configuration of an image forming system of an embodiment according to the present invention.

FIG. 3 is an explanatory drawing showing an example in which the bottom face of the area is defined by a first definition method.

FIG. 4 is an explanatory drawing showing an example in which the bottom face of the area is defined by a second definition method.

FIG. 5 is an explanatory drawing showing an example of the area information table in which the bottom face of the area is defined by the first definition method.

FIG. 6 is an explanatory drawing showing an example of the function restriction setting table.

FIG. 7 is an explanatory drawing showing an example of the security setting table.

FIG. 8 is an explanatory drawing showing an example of the area information table in which the bottom face of the area is defined by the second definition method.

FIG. 9 is a flow chart showing the operation where area information is accepted by the processing portion.

FIG. 10 is a flow chart showing the operation to set area information.

FIG. 11 is a flow chart showing the operation to set function restrictions.

FIG. 12 is a flow chart showing the operation to set security functions.

FIG. 13 is a front view showing an example of the screen on which the bottom face of the area is set by the first definition method.

FIG. 14 is a front view showing an example of the screen on which the bottom face of the area is set by the second definition method.

FIG. 15 is a front view showing an example of the screen on which the bottom face of the area is set in the plan view.

FIG. 16 is a front view showing an example of the screen on which priority of the area is set

FIG. 17 is a front view showing an example of the screen on which the area's function restriction mode is set.

FIG. 18 is a front view showing an example of the screen on which contents of the operation in the function restriction mode are set.

FIG. 19 is a front view showing an example of the screen on which the area's security mode is set.

FIG. 20 is a front view showing an example of the screen on which contents of the operation in the security mode are set.

FIG. 21 is a flow chart showing the operation where a job input is accepted by the processing portion that has accepted the operation settings.

FIG. 22 is a flow chart showing the operation of the printer driver that inputs a job into the processing portion that has accepted the operation setting.

FIG. 23 is an explanatory drawing showing an example of the area information table in which the bottom face of the area is defined by the first definition method and the applicable period is set.

FIG. 24 is an explanatory drawing showing an example of the area information table in which the bottom face of the area is defined by the second definition method and the applicable period is set.

### DETAILED DESCRIPTION OF THE PREFERRED EMBODIMENT

Hereafter, embodiments of the present invention will be described with reference to the drawings.

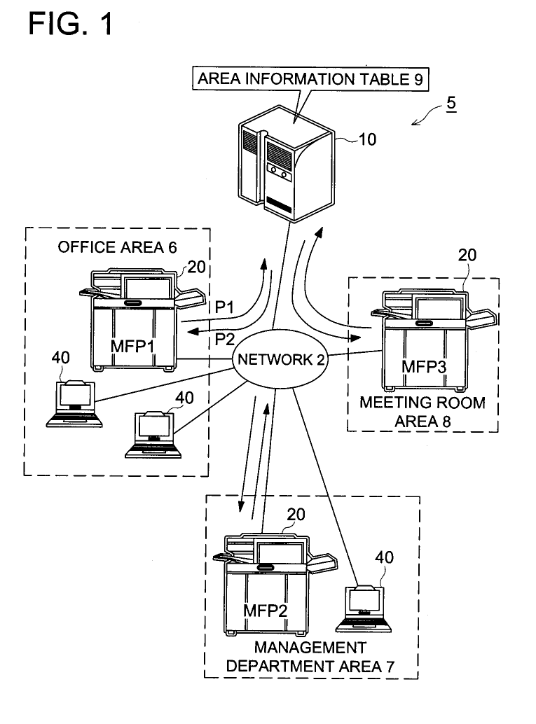

FIG. 1 shows the schematic configuration and the schematic operation of the image forming system 5 of an embodiment according to the present invention. The image forming system 5 comprises a processing portion 20 provided with a function to execute jobs related to image formation, such as copying and printing of manuscripts, and a control portion 10 to restrict the function of the processing portion 20 according to the installation location thereof via a connected network 2, such as a LAN (Local Area Network). Moreover, the network 2 within this image forming system may have a wire connection or a wireless connection. Furthermore, terminals 40, such as personal computers, are connected to the network 2.

The control portion 10 is, for example, an information processing apparatus that functions as a server. The control portion 10 stores the area range information which defines the location and the range of the area, such as an office or meeting mom, where the processing portion 20 is installed, and the area information table 9 where the functions restricted to the area are correspondingly registered.

The processing portion 20 is an image forming apparatus provided with a function to execute jobs related to image formation. It is configured as, for example, a digital Multi Function Printer (MFP) equipped with a copying function to read a manuscript image by a scanner and print out the duplicated image, a scanning function to store as a file the manuscript image read by the scanner, a PC printing function to print out printing data received from external terminals, and a facsimile transmission function. Furthermore, the processing portion 20 is provided with a security management function to manage the use authority of the apparatus and prevention of information leakage.

The processing portion 20 is equipped with a function (e.g., a GPS function) to recognize the location where the apparatus itself is installed, and communicates the installation location (position coordinates, or the like) recognized by that function to the control portion 10 (P1). The control portion 10 that received the notification refers to the area information table 9, identifies the area where the processing portion 20 is installed, and then sends an instruction of the function restriction associated with the area to the processing portion 20 (P2); subsequently, the processing portion 20 that received the instruction controls its own function according to the instruction.

For example, in FIG. 1, it is assumed that the office area 6, the management department area 7, and the meeting room area 8 are defined, as the office area 6 having no function restriction, the management department area 7 having a restriction to the copying function, and the meeting room area 8 having a restriction to the printing function and the facsimile function. When the control portion 10 receives a notification of the installation location from the MFP 1, since the installation location is included in the office area 6 registered in the area information table 9, the control portion 10 sends an instruction of the function restriction correspondingly registered in the office area 6 to the MFP 1. In this case, no function restriction is reported, and the MFP 1 that received the notification sets the apparatus itself to the condition where there is no function restriction.

Likewise, when a notification of the installation location is received from the MFP 2, since the installation location is included in the management department area 7 registered in the area information table 9, an instruction as to the restriction to the copying function correspondingly registered in the management department area 7 is sent to the MFP 2. When a notification of the installation location is received from the MFP 3, since the installation location is included in the meeting room area 8, an instruction as to the restriction to the printing function and the facsimile function correspondingly registered in the management department area 7 is sent to the MFP 3. Thus, functions of each MFP are subject to restrictions according to the installation location.

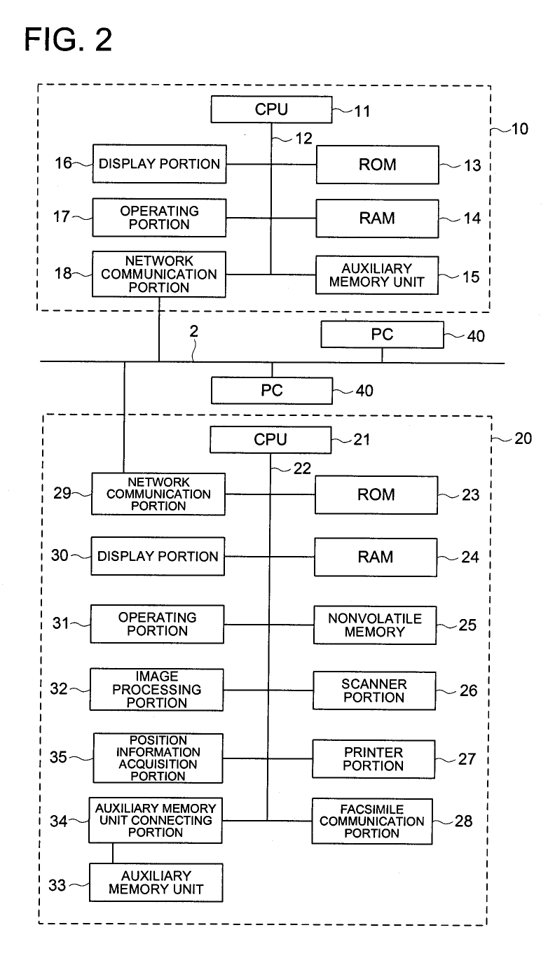

FIG. 2 is a block diagram showing the control portion 10 and the processing portion 20 which constitute an image forming system 5 of an embodiment according to the present invention. The control portion 10 is configured such that a ROM (Read Only Memory) 13, a RAM (Random Access Memory) 14, an auxiliary memory unit 15, a display portion 16, an operating portion 17, and a network communication portion 18 are connected via the bus 12 to the CPU (Central Processing Unit) 11 that exercises integrated control over the operation of the control portion 10.

Since the ROM 13 stores various kinds of programs, and by the CPU 11 executing those programs, each function of the control portion 10 is implemented. The RAM 14 is a random access memory used as a work memory that temporarily stores a variety of data when the CPU 11 executes programs.

The auxiliary memory unit 15 is a large capacity nonvolatile storage unit which functions as a storage portion in which area-related information, such as an area information table, is stored. The auxiliary memory unit 15 is composed of, for example, a hard disk drive.

The display portion 16 functions as a UI (User Interface) which displays a variety of operation screens, setting screens, guide screens, and warning screens. The display portion 16 is composed of, for example, a display apparatus, such as a Liquid Crystal Display (LCD).

The operating portion 17 has functions to receive various kinds of operations from a user and communicate the operations to the CPU 11. The operating portion 17 is composed of, for example, an input device such as a keyboard.

The network communication portion 18 communicates with the processing portion 20 and terminal devices (e.g., terminals 40) such as personal computers, via a network 2 and transmits a variety of data and information.

The processing portion 20 is configured as an MFP, as stated above, provided with the copying function, the printing function, the facsimile function, and the security management function for managing the use authority of the apparatus and prevention of information leakage. The processing portion 20 is configured such that a ROM 23, a RAM 24, a nonvolatile memory 25, a scanner portion 26, a printer portion 27, a facsimile communication portion 28, a network communication portion 29, a display portion 30, an operating portion 31, an image processing portion 32, an auxiliary memory unit connecting portion 34, and a position information acquisition portion 35 are connected via the bus 22 to the CPU 21 which exercises integrated control over the operation of the processing portion 20. The auxiliary memory unit connecting portion 34 subordinates and connects an auxiliary memory unit 33.

The ROM 23 stores various kinds of programs, and by the CPU 21 executing those programs, each function of the control portion 20 is implemented. The RAM 24 is a random access memory used as a work memory for temporarily storing a variety of data, an image memory for storing images, and a communication buffer for temporarily storing transmission-related data when the CPU 21 executes programs.

The nonvolatile memory 25 is a rewritable memory in which stored data is maintained after the power supply is turned off. The nonvolatile memory 25 stores the settings made for the processing portion 20. For example, the function restriction settings and the security settings inputted from the control portion 10 are stored in the nonvolatile memory 25.

The scanner portion 26 optically reads a manuscript to obtain image data. The scanner portion 26 comprises, for example, a light source for radiating light onto a manuscript, a line image sensor for receiving the reflected light and reading one line of manuscript in the direction of the width, a transportation means for sequentially moving a reading position line by line in the direction of the length of manuscript, an optical path composed of lens and mirror that direct reflected light from the manuscript to the line image sensor to form an image, and a conversion portion for converting the analog image signal outputted from the line image sensor into the digital image signal.

The printer portion 27 prints images according to image data on the recording paper. Herein, the printer portion 27 is configured as a laser printer comprising a recording-paper conveying apparatus, a photoreceptor drum, an electrical charging apparatus, a laser unit, a development apparatus, a transcription apparatus, a separation apparatus, a cleaning apparatus, and a fixing apparatus, wherein images are formed by the electrophotographic process.

The facsimile communication portion 28 is designed to control communication for sending and receiving facsimile, make a call request (dialing), respond to a call-in, and connect to a phone line.

The network communication portion 29 communicates with the control portion 10 and terminal devices (e.g., terminals 40) such as personal computers, via a network 2 and transmits/receives a variety of data and information.

The display portion 30 functions as a UI which displays a variety of operation screens, setting screens, guide screens, and warning screens. The display portion 30 is composed of, for example, a liquid crystal display.

The operating portion 31 has functions to accept various kinds of operations from a user and notify the CPU 21. The operating portion 31 is composed of, for example, a touch panel disposed on the screen of the display portion 30, other numeric keypads, a start button, and function mode keys.

The image processing portion 32 has a rasterizing function to convert printing data received from an external terminal apparatus into image data (bit map data), image compression and expansion functions, and an image rotation function.

The auxiliary memory unit 33 is a large-capacity nonvolatile storage unit, which stores data with a large amount of information, such as image data of a manuscript read by the scanner portion 26. The auxiliary memory unit 33 is, for example, a hard disk drive. Furthermore, settings stored in the nonvolatile memory 25 may be stored in the auxiliary memory unit 33.

The position information acquisition portion 35 has a function to identify the location where the processing portion 20 is installed. The position information acquisition portion 35 uses a GPS to obtain three-dimensional position coordinates of the location where the processing portion 20 is installed.

Next, the area information settings stored in the auxiliary memory unit 15 (storage portion) of the control portion 10 will be described. The area is specified as a three-dimensional space including the direction of the height. Herein, there are provided two area definition methods: a first definition method where the bottom face of the three-dimensional space (hereinafter, referred to as the bottom face of the area) is defined by a quadrangle framed in by four points, and a second definition method where the circular bottom face is defined by the center point and the radius. Information that defines the area is referred to as area range information. Moreover, the area defined by the area range information is called an “area range”.

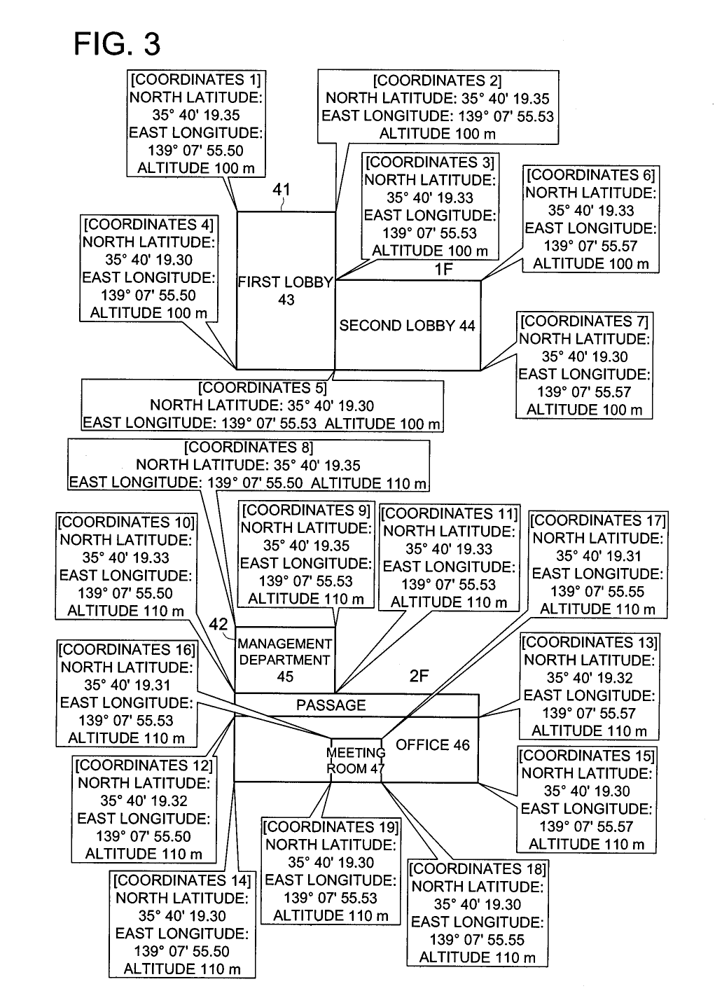

First, the first definition method will be described. FIG. 3 shows an example of the plan view (layout chart) of the first floor (1F) and the second floor (2F) of the building where the processing portion 20 is installed. In this example, lobbies 43 and 44 are located on the first floor (floor 41), and the management department 45, the office 46, the meeting room 47, and the passage are located on the second floor (floor 42). Furthermore, in FIG. 3, position coordinates (latitude, longitude, and altitude) of the four corners of each quadrangular region of the lobbies 43 and 44, office 46, meeting room 47, and the management department 45 are indicated.

In the first definition method, within the area range information, as information to define the bottom face of the area, the position coordinates of four points which become the vertices of a quadrangle are set. For example, when defining the entire management department 45 as one area (management department area), four points, which are coordinates 8, coordinates 9, coordinates 10, and coordinates 11, may be set as information that defines the bottom face of the area.

Furthermore, if it is difficult to define the target region by the quadrangle having vertices of the four-point position coordinates, it is possible to divide the target region into a plurality of quadrangular areas and make a setting for the collective entity. For example, when setting the entire first floor (floor 41) as a lobby area, first, two lobby areas are set: a first lobby area where the bottom face of the area is a quadrangle (first lobby 43) having vertices of coordinates 1, coordinates 2, coordinates 4, and coordinates 5, and a second lobby area where the bottom face of the area is a quadrangle (second lobby 44) having vertices of coordinates 3, coordinates 5, coordinates 6, and coordinates 7. Next, the range that combines the first lobby area and the second lobby area is set as a lobby area. By doing so, it is possible to set an arbitrarily shaped region, which cannot be defined by one quadrangle, as one area.

Furthermore, it is possible to set the priority for each area the range of which is defined by area range information. When the installation location of the processing portion 20 belongs to a plurality of areas, the control portion 10 identifies the highest priority area among those overlapped areas and recognizes the area as the area where the processing portion 20 is installed.

For example, in FIG. 3, the meeting room 47 is located in the office 46. Herein, if an office area where the bottom face of the area is a quadrangle (office 46) having vertices of coordinates 12, coordinates 13, coordinates 14, and coordinates 15, and a meeting room area where the bottom face of the area is a quadrangle (meeting room 47) having vertices of coordinates 16, coordinates 17, coordinates 18, and coordinates 19 are set, the meeting room area is overlapped with a portion of the office area. For this reason, the position coordinates of the processing portion 20 installed in the meeting room 47 are included both in the meeting room area and in the office area. However, if the priority of the meeting room area is set higher than the priority of the office area, the processing portion 20 determines that the processing portion 20 is installed in the meeting room area. By doing so, the control portion 10 can uniquely determine the area to which the processing portion 20 installed in the meeting room belongs, instead of excluding the portion of area overlapped with the meeting room 47 from the entire office area and setting up the remaining office area by combining a plurality of quadrangles. Consequently, it is possible to reduce the number of man-hours related to the area setting.

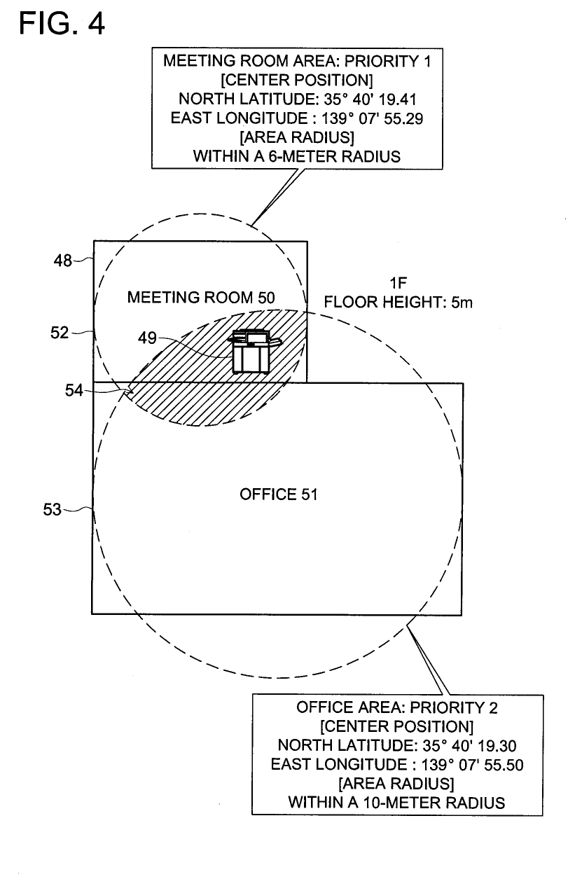

Next, the second definition method will be described. FIG. 4 shows an example of the plan view of the first floor (1F) of the building for which the area range information is set. In FIG. 4, the meeting room 50 and the office 51 are located on the first floor (floor 48) of the building. When setting the meeting room 50 on the floor 48 as a meeting room area 52 and setting the office 51 on the floor 48 as an office area 53, the center coordinates and the radius (area radius) of each area are set. By doing so, the area the bottom face of which is a circle having a center at the center coordinates and a radius which is the area radius is defined. The position coordinates which define the center position of each area are obtained, for example, by a GPS. The position coordinates are three-dimensional position coordinates composed of three values: latitude, longitude, and altitude.

In the above setting method, three-dimensional position coordinates required for setting the bottom face of the area are those of the center position of the area only; therefore, when compared to the first definition method, it is possible to set the bottom face of the area by an easy and simple input. Furthermore, when the target bottom face of the area closely resembles a circle, the area range can be approximated by the coordinates of one position without setting a large number of position coordinates.

Furthermore, in the same manner as the first definition method, priority can be set for each area defined by area range information. Since the bottom face of the area is circular in the second definition method if, for example, almost all area of the quadrangular office 51 is intended to be included in the area range, the area range expands to the outside of the target range. Therefore, as shown in FIG. 4, if the meeting room area 52 and the office area 53 the bottom faces of which are circular are set for the meeting room 50 and the office 51 located adjacent to each other so that almost entire target range can be included in those areas, an overlapped area portion 54 where those areas are overlapped is consequently generated. If the processing portion 20 is installed in the overlapped area portion 54, the position coordinates consequently belong to a plurality of areas. Accordingly, by setting different priorities for those areas, the control portion 10 can identify a high priority area as the area to which the processing portion 20 belongs. For example, in FIG. 4, assuming that the priority of the meeting room area 52 is set at 1 and the priority of the office area 53 is set at 2, the control portion 10 determines that the MFP 49 installed in the overlapped area portion 54 is located in the meeting room area 52.

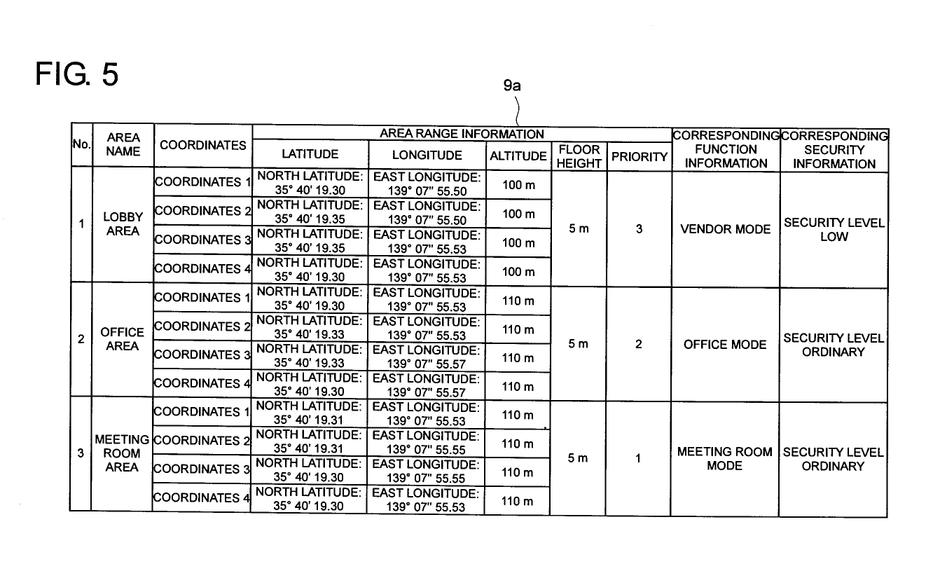

As an example of the area information table 9, FIG. 5 shows the area information table 9a where the bottom face of the area is defined by the aforementioned first definition method. In the area information table 9a, the area name, the area range information that defines the range (three-dimensional space) of the area, the corresponding function information that defines function restriction of the processing portion 20 installed in the area, and the corresponding security information that defines the operation of the security management function of the processing portion 20 installed in the area are registered in association with one another for each area.

The area range information comprises the position coordinates of respective four vertices of the quadrangular bottom face of the area, the floor height, and the priorities. The coordinates of each position are three-dimensional position coordinates composed of latitude, longitude, and altitude. The floor height indicates the height of the range of the area. According to the bottom face of the area and the height of the area, the range of the area is defined as a quadrangular prism assuming the bottom face of the area as a bottom face and the height of the area as a height. The priority is for the control portion 10 to determine the area where the processing portion 20 is installed when the coordinates of the location where the processing portion 20 is installed belong to a plurality of areas as mentioned above.

In the area information table 9, the function mode name is registered as the corresponding function information. The function mode is a set of registered settings as to whether to permit or restrict respective functions of the processing portion 20.

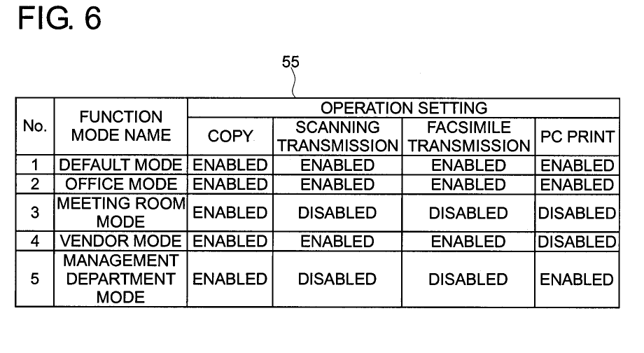

FIG. 6 shows an example of the function information table 55 where function mode related settings have been registered. The function information table 55 is stored in the auxiliary memory unit 15 of the control portion 10. In the function information table 55, the function mode name and the operation setting as to whether to permit or restrict a plurality of respective functions are registered in association with each other for each registered function mode. In the example of FIG. 6, as operation settings, it is registered whether to permit or restrict the use of respective functions with regard to the copying function, the scanning transmission function (the function to send a manuscript image read by a scanner as a file), the facsimile transmission function, and the PC printing function (the function to print out printing data received from an external terminal).

If plural types of such function modes have been registered beforehand, it is possible to collectively make settings as to whether to permit or restrict a plurality of respective functions by simply selecting any one of the registered function modes. For example, in FIG. 6, the default mode, the office mode, the meeting mom mode, the vendor mode, and the management department mode have been registered as function modes. When the meeting mom mode is selected, settings are made so that the use of the copying function is permitted, but the use of other functions is prohibited; and when the management department mode is selected, settings are made so that the use of the copying function and the PC printing function is permitted, but the use of the scanning transmission function and the facsimile transmission function is prohibited.

Again, explanation will continue to be given with reference to FIG. 5. In the area information table 9a, the security mode name is registered as the corresponding security information. The security mode is a set of registered settings as to whether to permit or restrict respective security management functions.

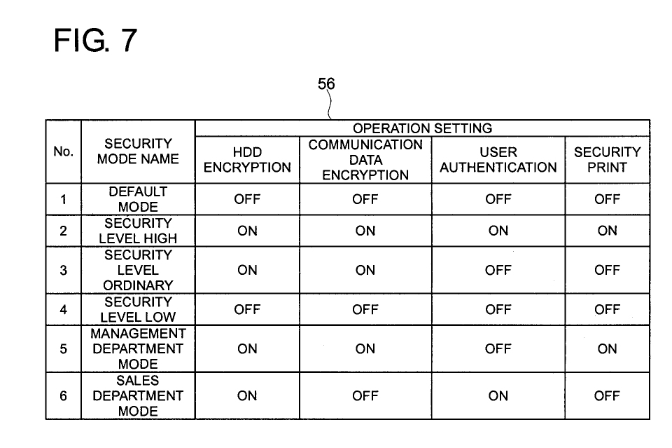

FIG. 7 shows an example of the security information table 56 where the security mode related settings have been registered. The security information table 56 is stored in the auxiliary memory unit 15 of the control portion 10. In the security information table 56, the security mode name and the operation setting as to whether to permit or restrict a plurality of respective security management functions are registered in association with each other for each registered security mode. In the example of FIG. 7, as operation settings, it is registered whether to operate respective functions with regard to the HDD encryption function (the function to execute encryption when information is stored in the auxiliary memory unit), the communication data encryption function (the function to encrypt information to be sent), the user authentication function (the function to verify whether a person who tries to use the processing portion 20 is authorized or not according to the password or the like), and the security printing function (the function to verify whether a person who tries to print a document is authorized or not according to the password or the like).

In the same manner as the aforementioned function mode, it is possible to collectively make settings as to a plurality of security management functions by simply selecting any one of the security modes that have been registered beforehand. Consequently, it is possible to reduce the number of man-hours related to the security management function setting. For example, in FIG. 7, the registered security modes include security level High, security level Ordinary, security level Low, the management department mode, and the sales department mode. When security level Ordinary is selected, settings are made so that the HDD encryption function and the communication data encryption function can operate but other security functions cannot operate; and when the management department mode is selected, settings are made so that only the user authentication cannot operate but other security functions can operate.

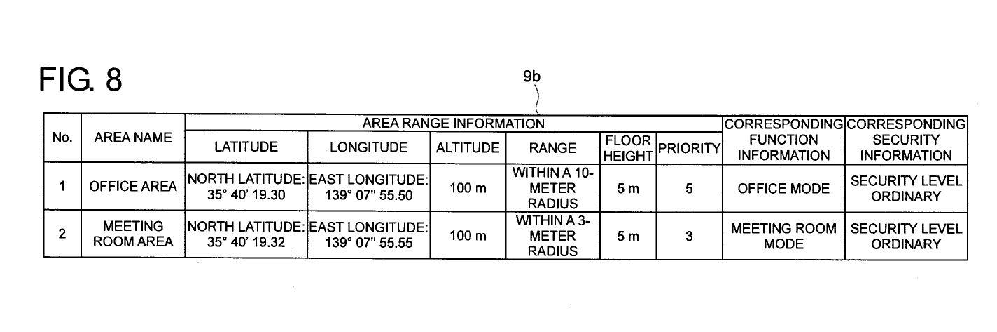

As an example of the area information table 9, FIG. 8 exemplifies the area information table 9b where the bottom face of the area is defined by the aforementioned second definition method. In the area information table 9b, the area name, the area range information that defines the range (three-dimensional space) of the area, the corresponding function information set for the area, and the corresponding security information set for the area are registered in association with one another for each area. Within the area range information, the item different from the area information table 9a shown in FIG. 5 is the information that defines the bottom face of the area and other items are the same as those of the area information table 9a in FIG. 5. In the area information table 9b, the latitude, the longitude, and the altitude that indicate the coordinates of the center position of the circular bottom face of the area, the area radius (“range” in the drawing), the floor height, and the priorities are registered as the area range information.

Next, the operation flow of the image forming system 5, wherein the control portion 10 makes settings for the functions of the processing portion 20 according to the installation location thereof; will be described.

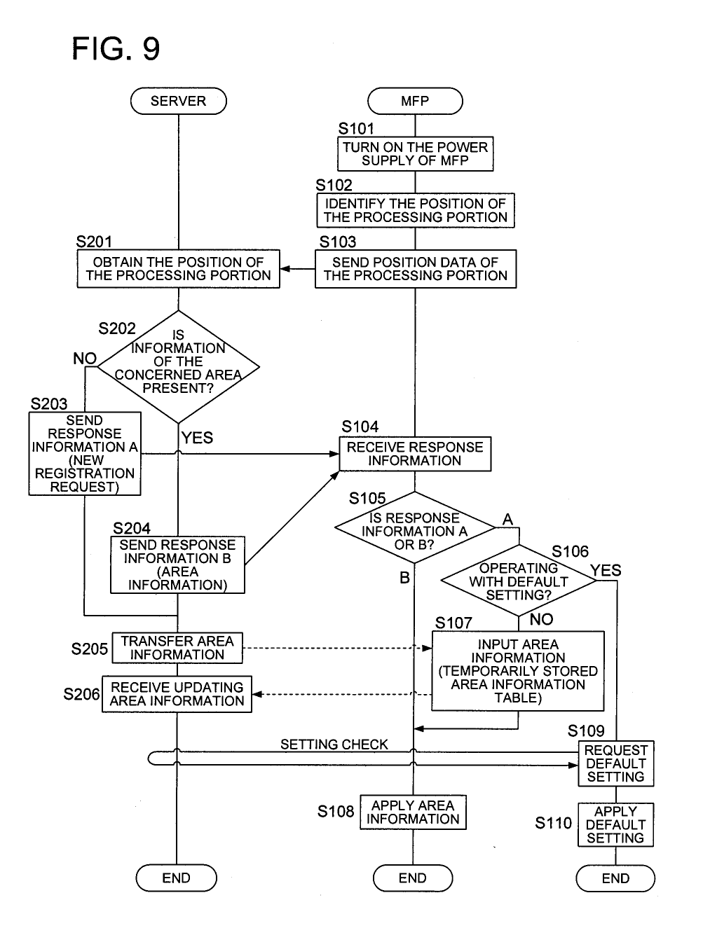

FIG. 9 shows the overall flow of the above operations. Herein, the MFP (processing portion 20) communicates its own installation location to the control portion 10 during the initial processing executed when the power is turned on, and then receives an instruction as to restriction to the functions from the control portion 10.

Specifically, when the processing portion 20 is turned on (step S101), the position information acquisition portion 35 obtains position coordinates of the location where the processing portion 20 is installed (step S102). The processing portion 20 communicates the position coordinates obtained by the position information acquisition portion 35 to the control portion 10 via a network 2 (step S103). When receiving the notification of the position coordinates from the processing portion 20 (step S201), the control portion 10 refers to the area range information registered in the area information table 9 stored in the auxiliary memory unit 15, and determines whether or not the area where the notified position coordinates are included in the area range has been registered in the area information table 9 (step S202).

When the area where the position coordinates are included in the area range has not been registered in the area information table 9 (step S202; No), the control portion 10 sends response information A, which is a request for new registration as to the area including the current installation location of the processing portion 20, to the processing portion 20 via a network 2 (step S203).

When the area where the position coordinates of the installation position of the processing portion 20 are included in the area range has been registered in the area information table 9 (step S202; Yes), the control portion 10 sends response information B, which is the area information (area range information and operation settings including function restriction settings and security function settings) registered in the area information table 9 in association with the concerned area, to the processing portion 20 via a network 2 (step S204). Moreover, when there are two or more concerned areas (i.e., when two or more areas that include the notified position coordinates have been set), the control portion 10 sends the area information, which has been registered in association with the area having the highest priority, to the processing portion 20.

Upon receiving response information from the control portion 10 via a network 2 (step S104), the processing portion 20 determines whether the received response information is response information A, which is a new registration request for the area including the current installation position of the processing portion 20, or response information B, which is the area information of the area where the processing portion 20 is installed (step S105). Upon receiving response information B from the control portion 10 (step S105; B), the processing portion 20 accepts the operation setting included in the area information received as response information B (step S108) and ends this process (end). By accepting the operation setting, the processing portion 20 restricts the function of the processing portion 20 according to the function restriction indicated by the operation setting, and conducts security function related operations according to the security function setting indicated by the operation setting. Moreover, the processing portion 20 stores the contents of the accepted operation setting as the MFP status, which will be described later.

When response information received from the control portion 10 is a new registration request (response information A) for the area including the installation position of the processing portion 20 (step S105; A), the processing portion 20 notifies the user via the display portion 30 functioning as a notification portion that the area where the current installation location of the processing portion 20 is included in the area range has not been registered in the control portion 10. This notification may be provided as an audio announcement or warning sound in addition to a warning display shown on the display portion 30. After completing this notification, the processing portion 20 confirms to the user whether to operate the processing portion 20 with the default setting or not (step S106). The default setting is an operation setting used when the processing portion 20 is installed at the position coordinates which has not been specified for an area. Contents of the function restriction in the default setting have been set as the default mode and registered in the function information table beforehand, and contents of the default setting related to the security function have been set as the default mode and registered in the security information table 56 beforehand.

The processing portion 20, when it receives an input to operate with the default setting (step S106; Yes), obtains the function restriction settings in the default mode registered in the function information table 55 and the security function operation settings in the default mode registered in the security information table 56 as the default settings (default operation settings) from the control portion 10 (step S109), accepts the default operation settings (step S110), and then ends the process (end).

The processing portion 20, when it receives an input not to operate with the default setting (step S106; No), displays the predetermined input screen on the display portion 30, and accepts via the operating portion 31 an input concerning a new input of area information where the installation location of the concerned processing portion 20 is included in the area range (step S107).

Upon receiving an input of area information from the user in step S107, the processing portion 20 receives the area information table 9 from the control portion 10 (step S205), and based on the received information, it displays data related to the area currently set. Specifically, the processing portion 20 stores the area information table (including the function information table 55 in FIG. 6 and the security information table 56 in FIG. 7) received from the control portion 10 in the nonvolatile memory 25 or the like as a temporarily stored area information table. Then, based on the temporarily stored area information table, the processing portion 20 displays current setting conditions on the area information input screen of the display portion 30. Furthermore, the processing portion 20 accepts a new area information setting on the area information input screen and updates the temporarily stored area information table according to the information. After the area information has been inputted, the processing portion 20 sends the updated temporarily stored area information table to the control portion 10 via a network 2.

Upon receiving the temporarily stored area information table from the processing portion 20, the control portion 10 compares the received area information table with the area information table 9 stored in the auxiliary memory unit 15 of the control portion 10, reflects the update to the area information table 9, and registers the data (step S206). The processing portion 20 makes operation settings related to the function restriction and security functions of the processing portion 20 based on the area information newly set in step S107 (step S108) and then ends the process (end).

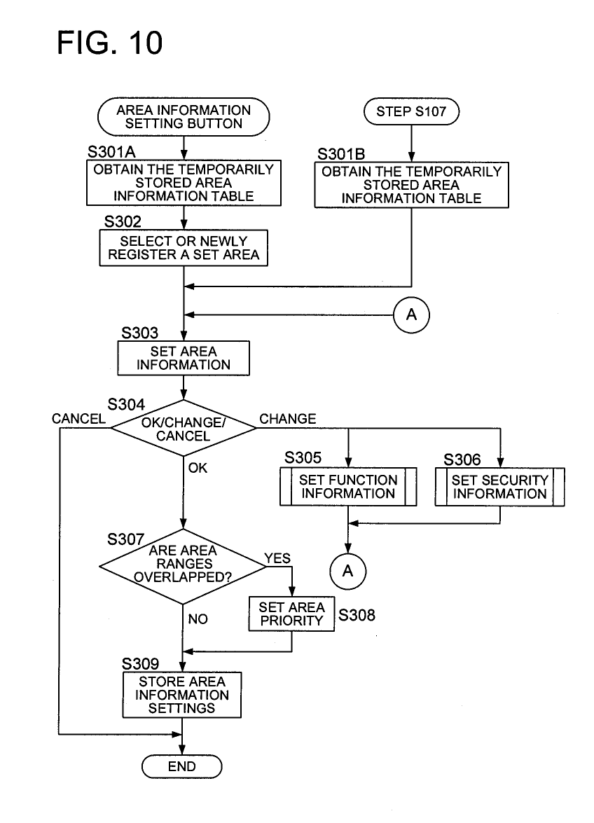

FIG. 10 shows the operation flow where the processing portion 20 accepts an input of area information. This procedure can be executed in two ways: by pressing a function button for area information setting located in the operating portion 31 of the processing portion 20 or by executing step S107 of FIG. 9. Moreover, the area selected as a setting input target in the procedure in FIG. 10 is called a “setting target area”.

When this operation is executed by pressing the aforementioned function button, the processing portion 20 obtains the area information table from the control portion 10, as stated above, and stores it as a temporarily stored area information table (step S301A). After that, the processing portion 20 displays the area selection screen, not shown, on the display portion 30, where a selection operation is made whether to newly input a piece of area information or to change registration of area information of the area registered in the area information table 9 (step S302). Herein, the screen appears where the list of area names that have already been registered and the new registration button are displayed, and when any area name in the list is selected, the area information input screen that displays area information of the area as default setting will be displayed. When the new registration button is selected, the area information input screen for new input where each input field is blank is displayed. Subsequently, the procedure proceeds to step S303, where the area information setting operation is enabled.

When this process is executed in step S107 (FIG. 9), the processing portion 20 obtains the area information table from the control portion 10, stores the table as a temporarily stored area information table (step S301B), and then the procedure proceeds to step S303, and the processing portion 20 accepts a new setting operation of a piece of area information.

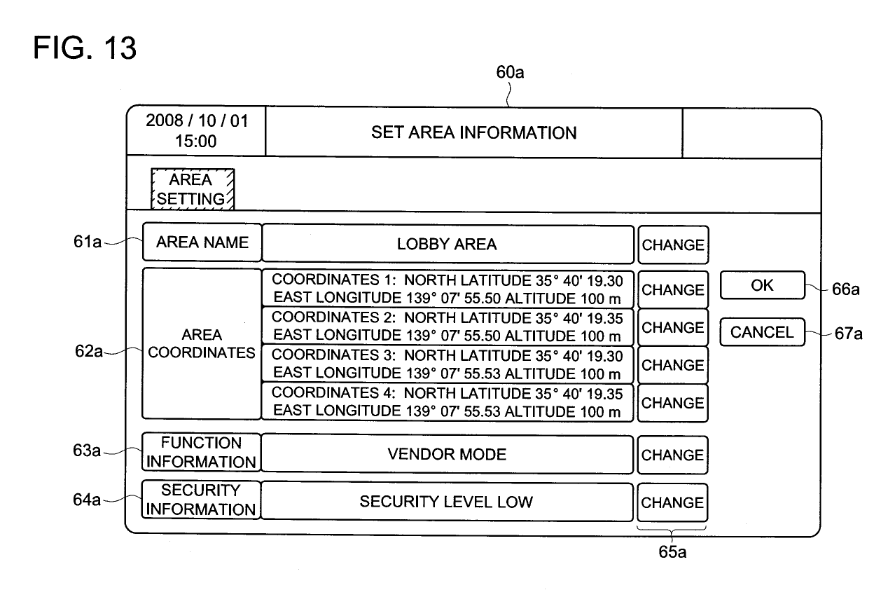

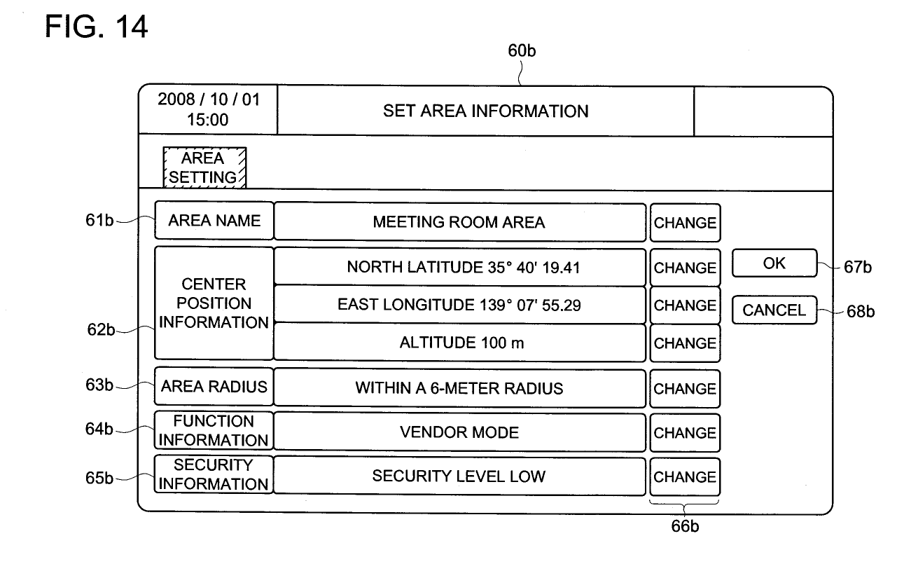

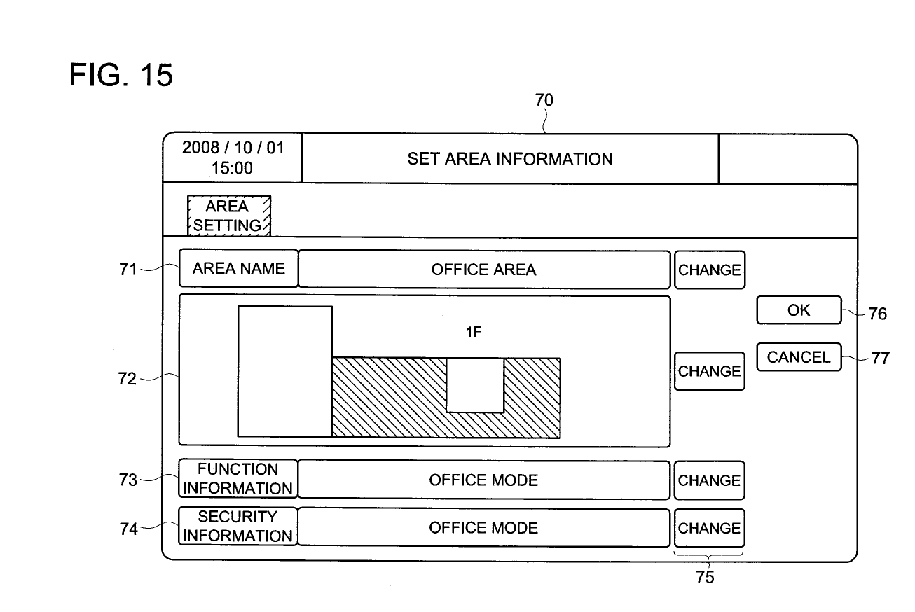

Herein, the area information input screen will be described. There are three types of area information input methods and the area information input screens include an area information input screen 60a (FIG. 13) where an input of the bottom face of the area is accepted by the first definition method, an area information input screen 60b (FIG. 14) where an input of the bottom face of the area is accepted by the second definition method, and an area range selection screen 70 (FIG. 15) where an area is selected on the plan view. Moreover, the area information input screen may be configured so that only one type can be used or a manager or a user can select one type.

Next, each area information input screen will be described.

FIG. 13 shows an example of the area information input screen 60a which enables settings to be made for the bottom face of the area by the first definition method. The area information input screen 60a displays the area name display field 61a where the area name of the setting target area is displayed, the area coordinate display field 62a where the position coordinates identifying the area range of the setting target area by the first definition method are displayed, the function information display field 63a where the function mode currently set for the setting target area is displayed, the security information display field 64a where the security mode currently set for the setting target area is displayed, the change button 65a provided for each display field and used for changing the setting displayed in the corresponding display field, the OK button 66a, and the cancellation button 67a. Pressing the change button 65a will pop up the screen where the setting in the corresponding display field can be changed, thereby enabling the settings to be changed. Pressing the OK button 66a, which is an operation button, will confirm the setting displayed in each display field on the area information input screen 60a. However, the OK button 66a cannot be pressed unless settings for all of the display fields have been made. The cancellation button 67a is a function button which is pressed to cancel various inputs made on the area information input screen 60a. Moreover, the area information input screen 60a in FIG. 13 is an example where area information that has been set is displayed as the default display; and when a piece of area information is newly inputted, all of the display fields is blank.

On the area information input screen 60a, the area coordinate display field 62a displays the settings of position coordinates of each vertex of the quadrangle constituting the bottom face of the area. When changing or newly inputting an area range, pressing the change button 65a that corresponds to the display field of the target position coordinates will pop up the screen where respective values (north latitude, east longitude, altitude) of the position coordinates can be changed, thereby enabling the settings of the position coordinates to be changed.

On the area information input screen 60a, the quadrangular bottom face of the area is defined by setting the position coordinates of four points in the area coordinate display field 62a. The three-dimensional quadrangular prism area range is defined by the position coordinates of the four points and the uniform area height specified beforehand by the manager. Moreover, configuration may be made such that an area height input field is provided on the area information input screen to set the area height for each area.

FIG. 14 shows an example of the area information input screen 60b which enables settings to be made for the bottom face of the area made by the second definition method. The area information input screen 60b displays the area name display field 61b where the area name of the setting target area is displayed, the center position information display field 62b where center position information of the area range of the setting target area is displayed, the area radius display field 63b where the area radius of the area range of the setting target area is displayed, the function information display field 64b where the function mode currently set for the setting target area is displayed, the security information display field 65b where the security mode currently set for the setting target area is displayed, the change button 66b which is provided for each display field and pressed to invoke the input screen where the setting displayed in the corresponding display fields can be changed, the OK button 67b, and the cancellation button 68b. Pressing the OK button 67b, which is an operation button, will confirm the setting displayed in each display field on the area information input screen 60b. However, the OK button 67b cannot be pressed unless settings for all of the display fields have been made. The cancellation button 68b is a function button which is pressed to cancel various inputs made on the area information input screen 60b. Moreover, the area information input screen 60b in FIG. 14 is an example where area information that has been set is displayed as the default display; and when a piece of area information is newly inputted, all of the display fields is blank.

On the area information input screen 60b, the center position display field 62b displays the settings of the position coordinates of the center of the circle constituting the bottom face of the area, and the area radius display field 63b displays the radius of the circle. When changing or newly inputting an area range, pressing the change button 66b that corresponds to the display field of the target position coordinates will pop up the screen where respective values (north latitude, east longitude, altitude, and radius) of the position coordinates can be changed, thereby enabling the settings of the position coordinates to be changed.

On the area information input screen 60b, the circular bottom face of the area is defined by setting the position coordinates of the center of the bottom face of the area in the center position information display field 62b and setting the radius of the bottom face of the area in the area radius display field 63b. The three-dimensional cylindrical column area range is defined by the position coordinates of the center, the radius, and the uniform area height specified beforehand by the manager. Moreover, configuration may be made such that an area height input field is provided on the area information input screen to set the area height for each area.

Furthermore, when setting area information initially by the use of the area information input screen 60b, configuration may be made such that the position coordinates at which the processing portion 20 is currently installed are automatically inputted into the center position information display field 62b.

FIG. 15 shows an example of the area range selection screen 70 which enables the area to be selected in the plan view. The area range selection screen 70 displays the area name display field 71 where the area name of the setting target area is displayed, the area range display field 72 where the plan view of the floor including the area range of the setting target area is displayed, the function information display field 73 where the function mode currently set for the setting target area is displayed, the security information display field 74 where the security mode currently set for the setting target area is displayed, the change button 75 which is provided for each display field and pressed to invoke the input screen where the setting displayed in the corresponding display field can be changed, the OK button 76, and the cancellation button 77. Pressing the OK button 76, which is an operation button, will confirm the setting displayed in each display field on the area range selection screen 70. However, the OK button 76 cannot be pressed unless settings for all of the display fields have been made. The cancellation button 77 is a function button which is pressed to cancel various inputs made on the area range selection screen 70.

On the area range selection screen 70, the area ranges that have been registered in the temporarily stored area information table are displayed in the plan view of each floor in the area range display field 72. It is possible to change the area range of the setting target area by selecting the area range in the plan view displayed in the area range display field 72 and pressing the selected area range. Furthermore, pressing the change button 75 that corresponds to the area range display field 72 will pop up the predetermined screen, where the floor can be changed, the location of the area range within the floor can be changed, or a new setting can be made, for example, by using the first or second definition method, or by plotting a rectangle in the plan view.

Furthermore, when the area range selection screen 70 is displayed, configuration may be made such that the area where the position coordinates at which the processing portion 20 is currently installed are included in the area range can be automatically selected as the setting target area.

Again, explanation will continue to be given with reference to FIG. 10. After the processing portion 20 have accepted an area information setting operation on any type of aforementioned area information input screens (step S303), when the OK button on the concerned area information input screen is pressed (step S304; OK), the procedure will proceed to step S307. When the function information change button on the area information input screen is pressed (step S304; change), the procedure will proceed to step S305. Furthermore, when the security information change button on the area information input screen is pressed (step S304; change), the procedure will proceed to step S306. After the procedures in step S305 and step S306 are finished, the procedure will return to step S303 (A). Moreover, on each area information input screen, settings of function information and security information can be made on the premise that the bottom face of the area (area range) has been set.

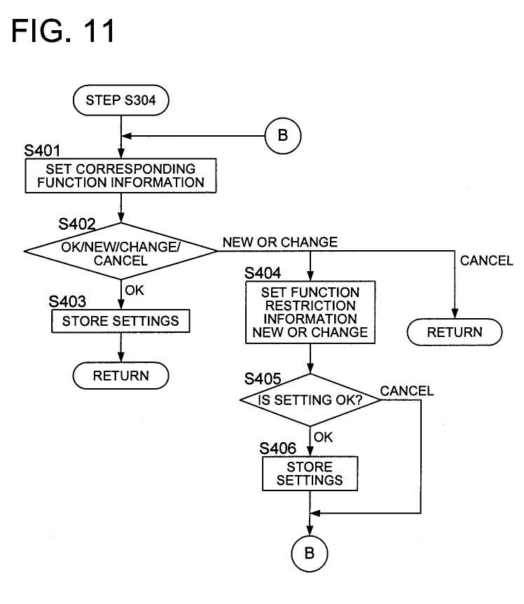

FIG. 11 shows an operation flow where the processing portion 20 accepts an input of function information. This process is executed in step S305 in FIG. 10. When this process is executed, the display portion 30 of the processing portion 20 displays the function information setting screen 90 (step S401).

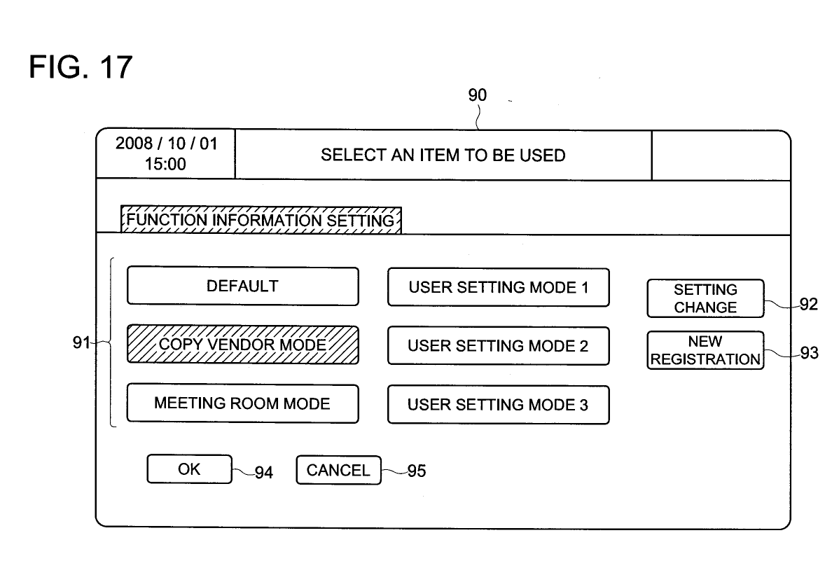

FIG. 17 shows an example of the function information setting screen 90 where the function mode for the setting target area can be set. The function information setting screen 90 displays the function mode button 91 provided for each function mode that has been registered, the setting change button 92 for changing the settings of the function mode selected by the function mode button 91, the new registration button 93 for newly setting a function mode, the OK button 94, and the cancellation button 95. When a new function mode is set, a function mode button 91 that corresponds to the newly set function mode is additionally displayed.

When the setting change button 92 is pressed while any function mode button 91 is selected, the function-mode separate-setting screen for changing the settings of the selected function mode is invoked and displayed. Pressing the OK button 94, which is an operation button, will confirm the setting inputted into the function information setting screen 90. The cancellation button 95 is pressed to cancel various inputs made on the function information setting screen 90.

For example, FIG. 17 shows the default mode function mode button, the copy vendor mode function mode button, the meeting room mode function mode button, and the function mode buttons in user setting mode 1 to user setting mode 3 where function restriction can be set anew.

Again, explanation will continue to be given with reference to FIG. 11. When the OK button 94 is pressed while any function mode button 91 has been selected, the processing portion 20 sets the selected function mode as a function mode for the setting target area. When the OK button 94 is pressed while any function mode button 91 is selected on the function information setting screen 90 (step S402; OK), the processing portion 20 confirms the selected function mode as the corresponding function information of the set target area, and accordingly, updates the temporarily stored area information table (step S403), and ends this process (return).

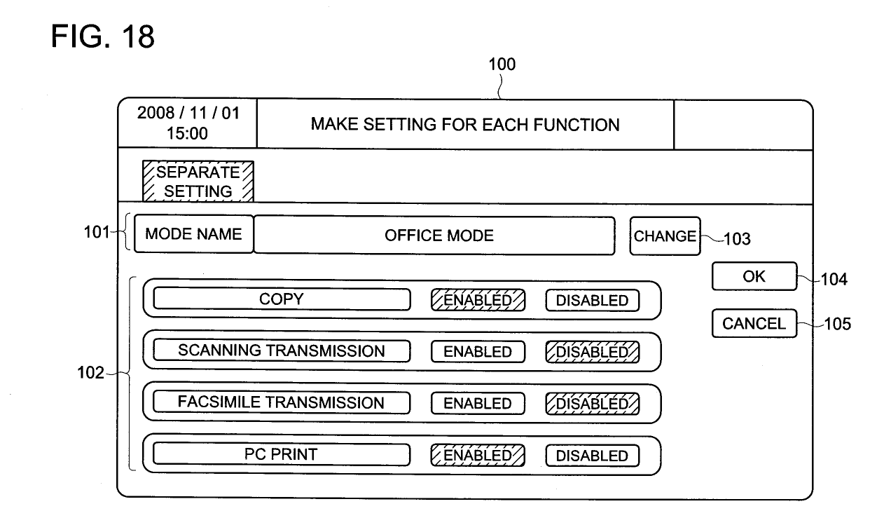

Furthermore, when the cancellation button 95 is pressed on the function information setting screen 90 (step S402; cancel), the processing portion 20 ends this process (return). When the setting change button 92 or the new registration button 93 is pressed on the function information setting screen 90 (step S402; new/change), the processing portion 20 displays the function-mode separate-setting screen 100 (FIG. 18) shown in FIG. 18 on the display portion 30 and accepts the function mode setting (step S404). When the accepted setting is registered (step S405; OK), the processing portion 20 stores the newly set or changed function mode in the temporarily stored area information table (the portion that corresponds to the function information table 55 in FIG. 6) (step S406), and ends this process. When the function mode setting is not registered (step S405; cancel), the procedure will return to step S401 and the processing portion 20 will display the function information setting screen 90 again (B).

FIG. 18 shows an example of the function-mode separate-setting screen 100 where function restriction in each function mode can be separately set. The function-mode separate-setting screen 100 displays the function mode display field 101 where the name (tentative name at new registration) of the function mode of the setting change target is displayed, the function setting field 102 where function restriction settings of the function mode of the setting change target are displayed, the change button 103 for changing the name of the function mode of the setting change target, the OK button 104, and the cancellation button 105.

The function setting field 102 displays the name of the function, the permission button, and the prohibition button for each restriction target function. The permission button is intended for making a setting to enable the use of the corresponding function, and the prohibition button is intended for making a setting to disable the use of the corresponding function. When either the permission button or the prohibition button is selected and pressed, selection of the other button is designed to be cancelled; thus, exclusive selection is executed. In FIG. 18, the selected button is displayed as being shaded.

The OK button 104 is an operation button that corresponds to “Setting OK” in step S405 of FIG. 11, and pressing the OK button 104 confirms the setting inputted into the function-mode separate-setting screen 100. The cancellation button 105 is a function button which is pressed to cancel various inputs made on the function-mode separate-setting screen 100.

For example, in FIG. 18, the name of the function mode of the setting change target is an office mode, and the function restriction settings in the office mode are: the copying function enabled, the scanning transmission disabled, the facsimile transmission disabled, and the PC printing function enabled. Moreover, when a new function restriction is set for the function mode, initial display shows the condition where the permission buttons are selected for all functions.

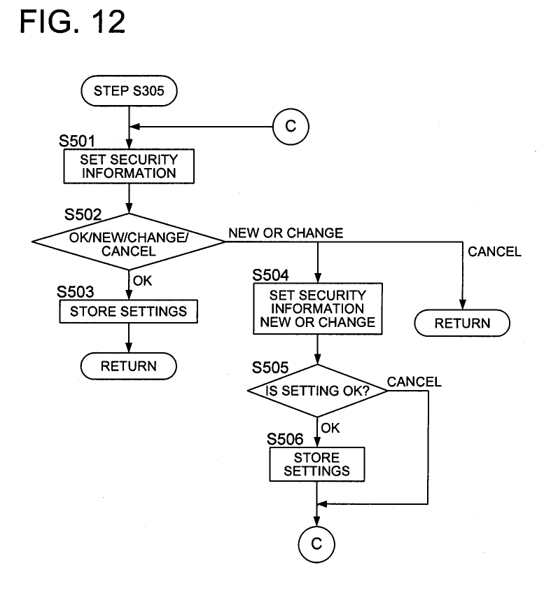

FIG. 12 shows the operation flow where the processing portion 20 accepts an input of security information. This process is executed in step S306 of FIG. 10. When this process is executed, the display portion 30 of the processing portion 20 displays the security information setting screen 110 (step S501).

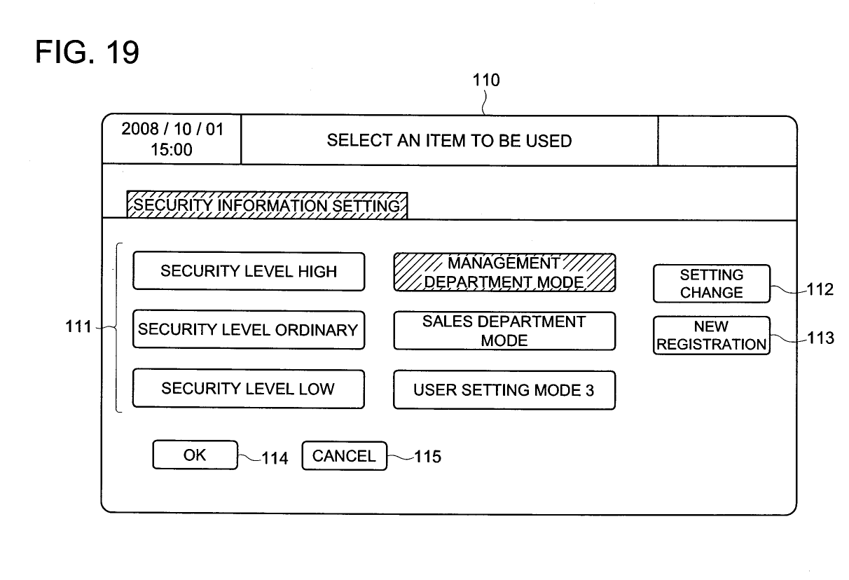

FIG. 19 shows an example of the security information setting screen 110 where the security mode setting of the setting target area can be made. The security information setting screen 110 displays the security mode button 111 provided for each security mode that has been registered, the setting change button 112 for changing the settings of the security mode selected by the security mode button 111, the new registration button 113 for newly setting a security mode, the OK button 114, and the cancellation button 115. When a new security mode is set, a security mode button 111 that corresponds to the newly set security mode is additionally displayed.

When the setting change button 112 is pressed while any security mode button 111 is selected, the security-mode separate-setting screen 120 for changing the On/OFF setting of each security function is invoked and displayed.

Pressing the OK button 114, which is an operation button, will confirm the setting inputted into the security information setting screen 110. The cancellation button 115 is pressed to cancel various inputs made on the security information setting screen 110.

For example, FIG. 19 shows the security mode buttons from security level High to Low, the management department mode security mode button, the sales department mode security mode button, and the security mode button for user setting mode 3.

Again, explanation will continue to be given with reference to FIG. 12. When the OK button 114 is pressed while any security mode button 111 is selected, the processing portion 20 sets the selected security mode for the security mode of the setting target area. When the OK button 114 is pressed while any security mode button 111 is selected on the security information setting screen 110 (step S502; OK), the processing portion 20 confirms the selected security mode as corresponding security information of the setting target area, and accordingly, updates the contents of the temporarily stored area information table (step S503), and ends this process (return).

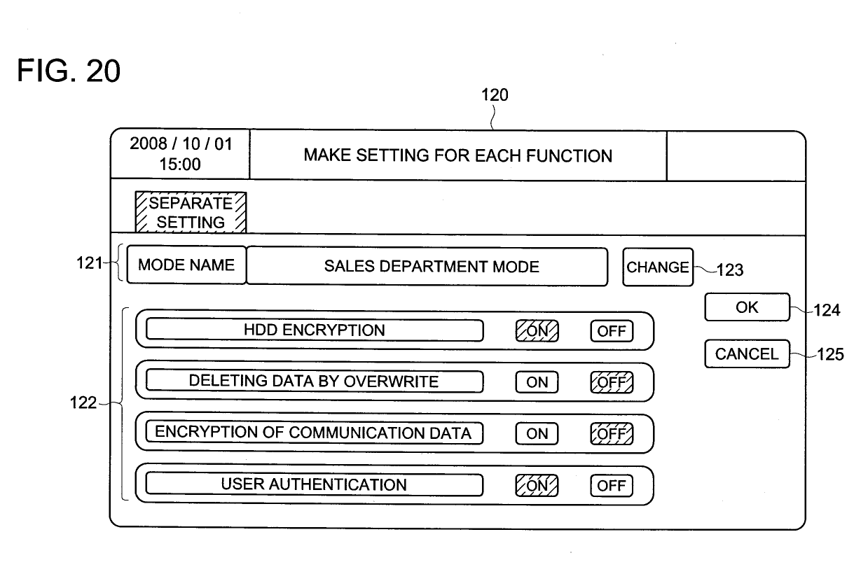

Furthermore, when the cancellation button 115 on the security information setting screen 110 is pressed (step S502; cancel), the processing portion 20 ends this process (return). When the setting change button 112 or the new registration button 113 on the security information setting screen 110 is pressed (step S502; new/change), the processing portion 20 displays the security-mode separate-setting screen 120 shown in FIG. 20 on the display portion 30 and accepts the security mode setting (step S504).

When the accepted setting is registered (step S505; OK), the processing portion 20 stores the newly set or changed security mode in the temporarily stored area information table (the portion that corresponds to the security information table 56 in FIG. 7) as corresponding security information of the setting target area (step S506), and ends this process. When the security mode setting is not registered (step S505; cancel), the procedure will return to step S501, and the processing portion 20 will display the security information setting screen 110 again (C).

FIG. 20 shows an example of the security-mode separate-setting screen 120 where security function operation in each security mode can be separately set. The security-mode separate-setting screen 120 displays the security mode display field 121 where the name (tentative name at new registration) of the security mode of the setting change target is displayed, the security setting field 122 where the security function settings for the security mode of the setting change target are displayed, the change button 123 for changing the name of the security mode of the setting change target, the OK button 124, and the cancellation button 125.

The security setting field 122 displays the name of the function, the “ON” button, and the “OFF” button for each security setting target function. The “ON” button is intended for making a setting so that the corresponding security function can always operate, and the “OFF” button is intended for making a setting so that the corresponding security function cannot operate. When either the “ON” button or the “OFF” button is selected and pressed, selection of the other button is designed to be cancelled; thus, exclusive selection is executed. In the drawing, the selected button is displayed as being shaded.

The OK button 124 is an operation button that corresponds to “Setting OK” in step S505 of FIG. 12, and pressing the OK button 124 confirms the setting inputted into the security-mode separate-setting screen 120. The cancellation button 125 is pressed to cancel various inputs made on the security-mode separate-setting screen 120.

For example, in FIG. 20, the name of the setting change target security mode is the sales department mode, and security function operations in the sales department mode are set as follows: ON for the HDD encryption, OFF for the deletion of data by overwrite, OFF for the communication data encryption, and ON for the user authentication. Moreover, when a security function operation is newly set for the security mode, initial display shows the condition where the “ON” buttons are selected for all functions.

Again, explanation will continue to be given with reference to FIG. 10. When the OK button on the area information input screen is pressed (step S304; OK), the procedure proceeds to step S307, where it is confirmed whether or not the area range of the setting target area is overlapped with the area range of other areas that have been registered in the temporarily stored area information table. When a part of or the entire area range of the setting target area is overlapped with the area range of other areas that have been registered in the temporarily stored area information table (step S307; Yes), the processing portion 20 accepts the priority setting for each overlapped area of the area range on the priority input screen (step S308). When the area range of the setting target area is not overlapped with the area range of other areas that have been registered in the temporarily stored area information table (step S307; No), the processing portion 20 registers (updates) the area information of the concerned area in the temporarily stored area information table (step S309), and ends this process (end).

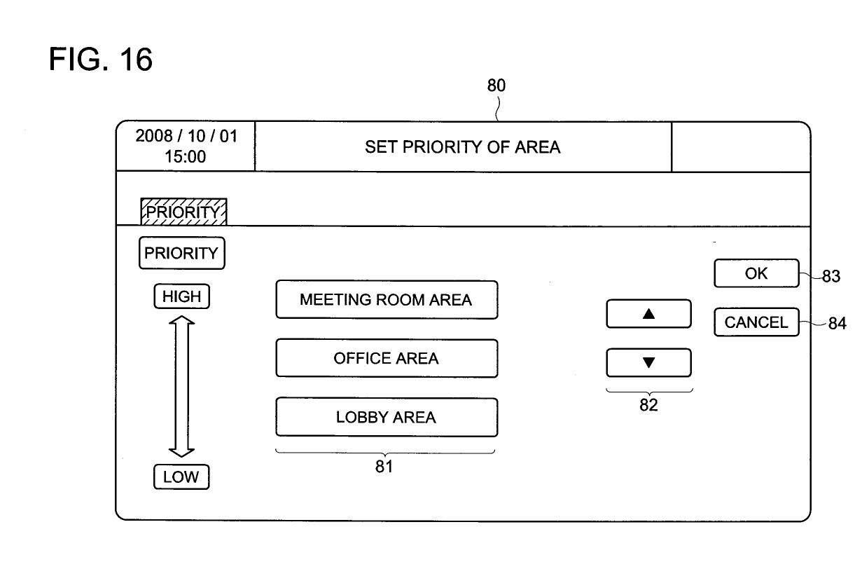

FIG. 16 shows an example of the priority input screen 80 where the priority settings of the areas can be inputted. The priority input screen 80 displays the area selection button 81 for each area registered in the temporarily stored area information table. Those area selection buttons 81 are vertically arranged in a row in sequential order of priority, set for the area that corresponds to the area selection button, from high to low priorities. Furthermore, the priority up and down buttons 82 for navigating up and down the levels of priority, the OK button 83, and the cancellation button 84 are also displayed. Pressing the OK button 83, which is an operation button, confirms the setting inputted into the priority input screen 80. The cancellation button 84 is a function button that is pressed to cancel various inputs made on the priority input screen 80.

For example, in FIG. 16, as area selection buttons 81, the meeting room area button, the office area button, and the lobby area button are sequentially displayed from top to bottom. It is possible to change priority of the area by operating the priority up and down buttons 82 so as to change the order of the arranged area selection buttons 81 while the area selection button 81 for the area the priority of which is to be changed is selected and pressed. Moreover, the priority of a newly registered area is initially set at the lowest priority.

Next, in the image forming system 5, explanation will be given about the operation of the processing portion 20 after it has accepted the operation setting inputted from the control portion 10 according to the installation location.

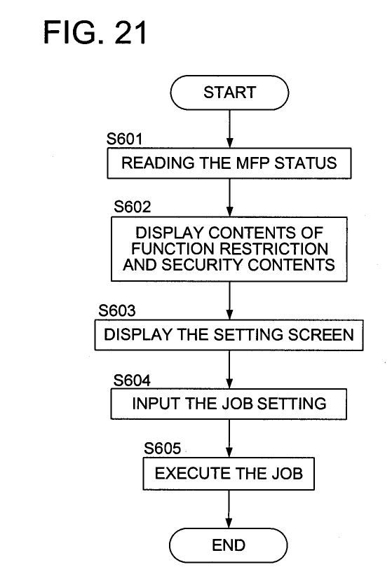

FIG. 21 shows the operations of the processing portion 20 when a user is operating an MFP (processing portion 20) via the operating portion 31 thereof after the MFP has accepted an operation setting from the control portion 10. When a user operates, the processing portion 20 accordingly reads out the stored MFP status (operation setting) (step S601), and displays the currently set function restrictions and security settings on the display portion 30 (step S602). In this process, when there is a restricted function, it is possible to notify the user of the restriction.

Subsequently, the processing portion 20 displays the setting screen which accepts a job input on the display portion 30 (step S603). In this process, the processing portion 20 displays the restricted function (operation button thereof, etc.) in grayout display or the like to prevent the concerned operation. When a job is inputted by operating via the setting screen (step S604), the processing portion 20 executes the specified job (step S605), and ends this process (end).

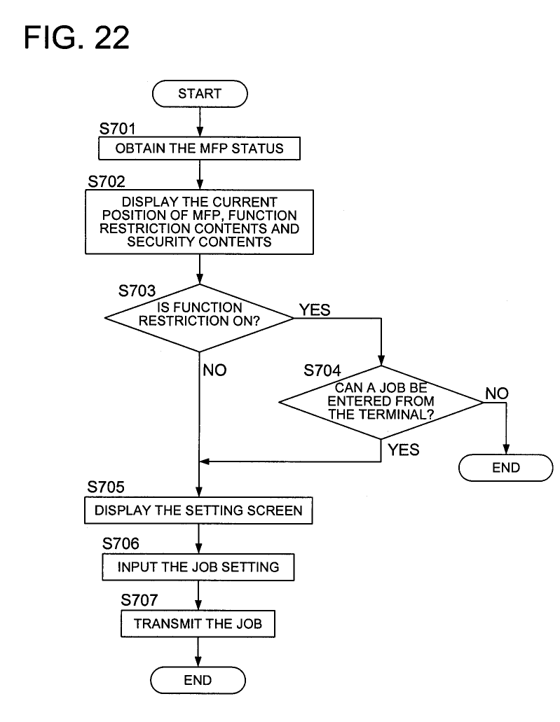

FIG. 22 shows the operation of the printer driver of the terminal 40 through which a job is inputted via a network 2 into the processing portion 20 (MFP) after the processing portion 20 has accepted the operation setting from the control portion 10. When the printer driver for the processing portion 20 is activated on the terminal 40, the printer driver obtains the current MFP status (operation settings, etc.) of the processing portion 20 from the processing portion 20 via a network 2 (step S701), and displays the contents of the MFP status on the display apparatus of the terminal 40 (step S702).

The printer driver of the terminal 40 determines based on the obtained MFP status whether or not the processing portion 20 accepts function restriction (step S703), and when the processing portion 20 accepts the function restriction (step S703; Yes), the printer driver determines whether or not there is a job that can be inputted without being subjected to the function restriction (step S704). When there is no job that can be inputted into the processing portion 20 from the terminal 40 due to the function restriction that the processing portion 20 accepts (step S704; No), the printer driver of the terminal 40 notifies the user of it, and ends this process (end).

When the processing portion 20 does not accept the function restriction (step S703; No), or when the processing portion 20 accepts the function restriction, but there is a job that can be inputted from the terminal 40 (step S704; Yes), the printer driver of the terminal 40 displays the setting screen where a job input is accepted on the display apparatus of the terminal 40 (step S705). In this process, the printer driver of the terminal 40 displays the restricted function (operation button thereof, etc.) in grayout display or the like to prevent the concerned operation. When the setting and inputting of the job is accepted via the setting screen (step S706), the printer driver of the terminal 40 sends the job to the processing portion 20 via a network 2 (step S707), and ends this process (end).

When the area where the processing portion 20 is installed is moved, the control portion 10 notifies the user of the movement of the processing portion 20 via another processing portion 20 or the terminal 40. With regard to this notification, it is possible to set the notification destination, notification timing, notification method, and notification contents beforehand in the control portion 10.

For the notification destination, a terminal within a specific IP address and a terminal registered in the control portion 10 can be specified. For the notification timing, arbitrary time interval, the time at which a job is inputted from the terminal, and any time when the movement occurs can be specified. For the notification method, the grayout display of the processing portion 20 in the printer list and the pop-up display of the predetermined notification screen on the terminal can be specified. For the notification contents, the changed operation settings of the processing portion 20, the name and the position coordinates of the area where the processing portion 20 is installed, and the difference between the position coordinates of the processing portion 20 and the previous position coordinates can be specified. Moreover, even when the processing portion 20 is moved within the area range of the same area, it is possible to set the operation so that the same notification as stated above can be made.

Next, a second embodiment will be described. In the first embodiment, the processing portion 20 is designed to always accept the operation setting of the area that corresponds to the installation location thereof; however, in the second embodiment, operation settings of the processing portion 20 can be made for each applicable period, such as a time zone, a day of the week, and the like. Other items are the same as those of the first embodiment, and therefore, explanation will be omitted accordingly. Besides the above, the applicable period can include the setting of the arbitrary start period and end period in the units representing day, month, or hour.

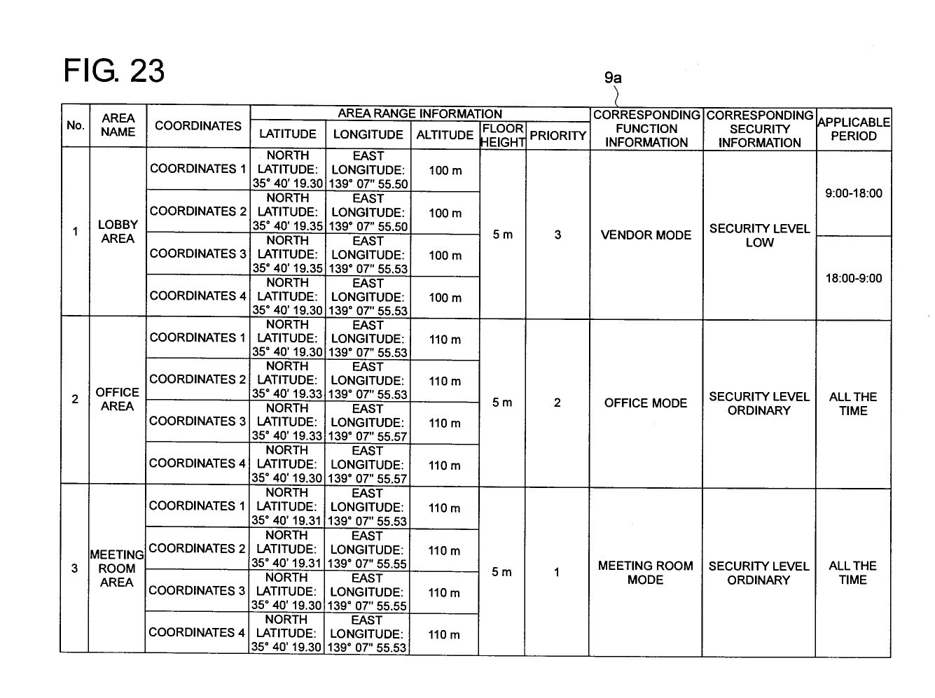

FIG. 23 shows an example of the area information table 9c where the bottom face of the area is defined by the first definition method and operation settings are made according to the applicable period. For example, in FIG. 23, the applicable period is set for the lobby area and the operation settings from 9:00 to 18:00 are: the vendor mode for the corresponding function information of the lobby area and the security level Low for the corresponding security information. Furthermore, operation settings from 18:00 to 9:00 are: the office mode for the corresponding function information of the lobby area, and the security level Ordinary for the corresponding security information.

The control portion 10 has a function to recognize current date and hour, and sequentially sends instructions of operation settings for the applicable period that includes current date and hour to the processing portion 20. For example, in the same manner as FIG. 9, the installation location is notified via the processing portion 20, the area of the processing portion 20 is identified, and data that associates the address (e.g., IP address) of the processing portion 20 with the identified area is registered as the monitoring target information. Furthermore, the applicable period registered as the area information of the area is compared with the current date and hour, the applicable period that includes the current date and hour is identified, and instructions for operation settings associated with the applicable period are sent to the processing portion 20.

Furthermore, with regard to the area registered in the monitoring target information, the control portion 10 monitors whether or not the applicable period that includes the current date and hour has changed, and when the applicable period has changed, operation settings associated with the applicable period after the change are sent to the concerned processing portion 20, and change of the operation setting is instructed.

By doing so, for example, settings of the processing portion 20 installed in the lobby area can be automatically changed so that it can operate as the MFP for the general public during the time zone when the lobby area is open to the public, and it can operate as the MFP for those who are concerned during the time zone when the lobby area is used by concerned people only. Consequently, it is possible to reduce the work to change the operation settings and prevent the change from being carelessly forgotten.

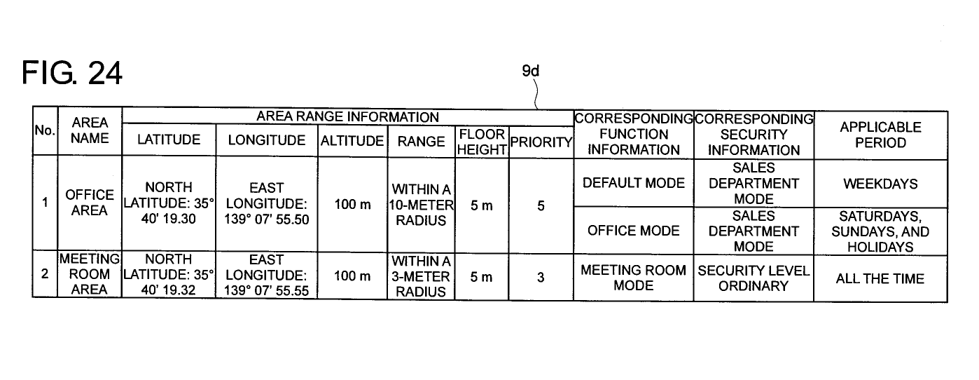

FIG. 24 shows an example of the area information table 9d where the bottom face of the area is defined by the second definition method and operation settings are made according to the applicable period. For example, in FIG. 24, the applicable period is set for the lobby area and the sales department area. The applicable period for the lobby area is the same as those of the lobby area mentioned above in FIG. 23. The operation settings of the sales department area during weekdays are: the default mode for the corresponding function information, and the sales department mode for the corresponding security information. Furthermore, operation settings on Saturdays, Sundays, and holidays are: the office mode for the corresponding function information of the sales department area, and the sales department mode for the corresponding security information. The holiday settings can be made such that a calendar is registered in the control portion 10 and holidays are recognized by referring to the calendar.

Thus, in the image forming system 5 according to this embodiment, operation settings of the functions and the like restricted in the area are registered beforehand for each area in the auxiliary memory unit 15 of the control portion 10, the installation location of the processing portion 20 is identified, and the instructions as to the operation settings according to the installation location are sent from the control portion 10 to the processing portion 20. Accordingly, function restrictions and security functions according to the installation location of the processing portion 20 can be set for the processing portion 20 automatically or with a small number of man-hours, thereby reducing the time and labor required for the setting.

The embodiments of the present invention have been described so far with reference to the drawings; however, specific configurations are not intended to be limited to those embodiments, and changes and additions that do not depart from the scope of the present invention are included in the present invention.

For example, UI displays of the display portion 30 shown in FIG. 13, FIG. 14, FIG. 15, FIG. 16, FIG. 17, FIG. 18, FIG. 19 and FIG. 20 are examples, and types of the UI display in the present invention are not limited to those.

Furthermore, in the embodiments, the system is configured such that the processing portion 20 and the control portion 10 are connected via a network 2; however, the system can be configured such that the control portion 10 and the processing portion 20 are incorporated into one apparatus. For example, the system may be configured as an image forming apparatus which includes all of the functions of the control portion 10 and the processing portion 20.

Furthermore, in the embodiments, the position information acquisition portion 35 uses a GPS to identify the position coordinates of the processing portion 20; however, identification may be executed by other methods. For example, a user may input information related to the installation position of the concerned processing portion 20 via the operating portion 31 of the processing portion 20, or for example, a user may select an area that corresponds to the current installation location from the list of the registered areas. In this process, an area name list or the like may be displayed to use an area name to select the area. Furthermore, configuration may be made such that an operation button to select the installation location is provided, and pressing the button will set the operation according to the installation location of the processing portion 20.

Moreover, an available method of identifying the installation position of the processing portion 20 is that a receiver installed in each floor or each mom receives the signal (e.g., signal that includes an apparatus number of the processing portion 20 as a piece of information) sent from a transmitter disposed in the processing portion 20, thereby identifying the installation position of the processing portion 20. In this case, configuration may be made such that the receiver notifies the control portion 10 of the installation location of the processing portion 20. That is, the receiver communicates the apparatus number received from the processing portion 20 and the information indicating the installation location of the concerned receiver to the control portion 10. Furthermore, configuration may be made such that a transmitter for sending the signal that includes information showing the location is installed in each floor or each room, and the processing portion 20 receives the signal thereby identifying the installation location of the processing portion 20.

Furthermore, configuration may be made such that when the processing portion 20 is installed at a location which is not included in the area registered in the area information table 9, or when the processing portion 20 is disconnected from the control portion 10, the processing portion 20 issues warning to notify that the processing portion 20 has been moved to an unauthorized location. Moreover, configuration may be made such that if a predetermined operation input is not made within a certain period of time to respond to the warning, all of the functions of the processing portion 20 are to be stopped.

Furthermore, in the embodiments, an MFP provided with a plurality of functions is shown as the processing portion 20; however, the MFP may be a single-function apparatus as long as the processing portion 20 can execute jobs related to image formation (image forming apparatus).

Furthermore, the area range definition method is not intended to be limited to those exemplified in the embodiments. For example, if an area is a rectangular parallelepiped space, it is possible to uniquely define the three-dimensional space as an area by defining the position coordinates of diagonally located two points. Furthermore, if the position coordinates of four points showing the bottom face or top face of the area and the value showing the height of the area are provided, the quadrangular prism-shaped area can be uniquely defined.

Functions that can be restricted and security functions are not limited to those exemplified in the embodiments. A portion of functions (e.g., the confidential printing function within the printing functions) can be restricted.

In the embodiments, position coordinates are considered as the absolute coordinates on the earth; however, for example, a location may be indicated by the relative position with regard to the reference point in the building.

Moreover, the processing portion 20 is not limited to the MFPs described in the embodiments and may be other types of image forming apparatus, such as copiers, printers, and fax machines.

In the above embodiment, the functions restricted in the area are registered beforehand in the storage portion for each area. The control portion executes the restriction of the function of the processing portion registered in the storage portion in association with the area where the installation location of the processing portion identified by the position information acquisition portion is included. By doing so, it is possible to easily change the settings of the function restriction of the processing portion according to the installation location. Moreover, it is preferred that the position information acquisition portion identifies the installation location of the processing portion automatically, or a user selects and inputs the meeting room, the lobby, and the like, related to the installation location, thereby the installation location of the processing portion can be identified.

In the above embodiment, the level of the security function in the area is registered beforehand in the storage portion for each area. The control portion executes the setting of the level of the security of the processing portion registered in the storage portion in association with the area where the installation location of the processing portion identified by the position information acquisition portion is included. By doing so, it is possible to easily change the level of the security of the processing portion according to the installation location. Moreover, it is preferred that he position information acquisition portion identifies the installation location of the processing portion automatically, or a user selects and inputs the meeting room, the lobby, and the like, related to the installation location, thereby the installation location of the processing portion can be identified.

In the above embodiment, because the location and the range of the area are defined by the plurality of the coordinates, the range of the area is set by the shape of high degree of freedom.

In the above embodiment, it is possible to define the area as a space that the bottom or upper face of which is a circle having a center at the reference position and a radius which is a distance from the reference position, or to define the area as a globe that centers on reference position. Moreover, if there is a value in which the altitude of the area is shown, the area is defined as an arbitrary columnar three dimension space. Therefore, it becomes easy to set the range in the area.

In the above embodiment, when the installation location of the processing portion is included in a plurality of the area, the control portion identifies the area where the priority is set highest in those areas as an area which processing portion is installed. As a result, even if the area where part or all of the area overlap with other areas is defined, the control portion uniquely identifies the area which the processing portion set up.

In the above embodiment, when a processing portion is installed in the area that is not stored in the storage portion, the effect is notified a user of. As a result, the user notices that a processing section was installed in the place that does not register, or was installed in the area where did not assume the use of this imaging system.

In the above embodiment, the function restricted can be set to the area according to the applicable period. The application period is set by the selection of time zone, the selection of a day of the week, and the selection of weekdays or weekends. For example, only the general function of a processing portion installed at the lobby area is executed at time zone that the lobby area is opened in general, on the other hand, the function restriction settings can be changed automatically so that only the function for parties concerned is executed at time zone that the lobby area is closed for parties concerned.

I In the above embodiment, the level of the security function can be set to the area according to the applicable period. The application period is set by the selection of time zone, the selection of a day of the week, and the selection of weekdays or weekends. For example, a processing portion installed at a department which handles high confidentiality document is executed so that only the limited user may use it in working hours that a confidential document is treated, and to need the user authentication function, on the other hand, the setting of the level of the security function can be changed automatically so that the user authentication should not is executed after the close of the work that the confidential document is not treated.

According to the image forming system in accordance with the present embodiment, it is possible to change functions and security items of the image forming apparatus automatically or with a small number of man-hours according to the installation location of the apparatus.

What is claimed is:

1. An image forming system comprises:
a processing portion provided with a function to execute jobs related to image formation;
a position information acquisition portion for identifying a location where the processing portion is installed;
a storage portion for storing an area and a function restricted in the area in association with each other, and
a control portion for obtaining from the storage portion the function stored in association with the area which includes the installation location of the processing portion identified by the position information acquisition portion is included, and restricting an execution of the job a related to the function of the processing portion.

2. The image forming system of claim 1,
wherein the area is defined by plurality of position coordinates.

3. The image forming system of claim 1,
wherein the area is defined by a reference position and a distance from the reference position.

4. The image forming system of claim 1,
wherein the storage portion stores a priority of the area in association with the area, and
the processing portion execute the obtaining according to a highest priority area among a plurality of the areas when the installation location of the processing portion identified by the position information acquisition portion is included in the plurality of the areas.

5. The image forming system of claim 1,
further comprise a notification portion which notifies an user that the storing is not executed, when the area which includes the installation location of the processing portion identified by the position information acquisition portion is not stored in the storage portion

6. The image forming system of claim 1,
wherein the storage portion stores the function restricted at the area for each applicable period; and,
the function that processing portion obtains from the storage portion is a function in association with related to a current applicable period when the present belongs, among the function in association with the areas including the installation location of the processing portion identified by the position information acquisition portion.

7. An image forming system comprises:
a processing portion provided with a function to execute jobs related to image formation and a security function for changing a setting of a level;
a position information acquisition portion for identifying a location where the processing portion is installed;
a storage portion for storing an area and a level of the security function that should be set in association with each other; and
a control portion for obtaining from the storage portion the level stored in association with the area which includes the installation location of the processing portion identified by the position information acquisition portion is included, and setting the level of the security function of the processing portion at the obtained level.

8. The image forming system of claim 7,
wherein the area is defined by plurality of position coordinates.

9. The image forming system of claim 7,
wherein the area is defined by a reference position and a distance from the reference position.

10. The image forming system of claim 7,
wherein the storage portion stores a priority of the area in association with the area, and
the processing portion execute the obtaining according to a highest priority area among a plurality of the areas when the installation location of the processing portion identified by the position information acquisition portion is included in the plurality of the areas.

11. The image forming system of claim 7,
further comprise a notification portion which notifies an user that the storing is not executed, when the area which includes the installation location of the processing portion identified by the position information acquisition portion is not stored in the storage portion

12. The image forming system of claim 7,
wherein the storage portion stores the function restricted at the area for each applicable period; and,
the function that processing portion obtains from the storage portion is a function in association with related to a current applicable period when the present belongs, among the function in association with the areas including the installation location of the processing portion identified by the position information acquisition portion.

13. The image forming system of claim 7,
wherein the storage portion stores a level of the security function that should be set in association with the area for each applicable period; and,
the level that processing portion obtains from the storage portion is a level in association with a current applicable period, among the levels in association with the areas including the installation location of the processing portion identified by the position information acquisition portion.
